(19) United States
(12) Patent Application Publication
(10) Pub. No.: US 2009/0132919 A1
(43) Pub. Date: May 21, 2009

(54) Appending Hover Help to Hover Help for a User Interface

(75) Inventors: Lloyd W. Allen, Jr., Cary, NC (US); Jana H. Jenkins, Raleigh, NC (US); Steven M. Miller, Cary, NC (US)

Correspondence Address: MARCIA L. DOUBET LAW FIRM, PO BOX 422859, KISSIMMEE, FL, 34742, US

(73) Assignee: INTERNATIONAL BUSINESS MACHINES CORPORATION, Armonk, NY (US)

(21) Appl. No.: 11/941,051

(22) Filed: Nov. 15, 2007

(51) Int. Cl. G06F 3/048

(52) U.S. Cl. 715/708

(57) ABSTRACT

Enabling end users to add their own hover help to extend hover help that is provided in a user interface, without having access to the code of the application. An end user can extend the application-provided hover help information to make it more helpful or tailored to his own needs. The originally-provided hover help is retained, and may be rendered in addition to the user's appended hover help. Or, by specifying that the user-provided hover help is displayed in the same location as the originally-provided hover help, the user-provided hover help can be rendered such that the originally-provided hover help is at least partially obscured.

### CROSS-REFERENCE TO RELATED APPLICATION

Commonly-assigned U.S. patent application Ser. No. ______, which is titled “Modifying Hover Help for a User Interface” and which was filed concurrently herewith.

### BACKGROUND OF THE INVENTION

The present invention relates to computers, and deals more particularly with enabling end users to add their own hover help to extend hover help that is provided in a user interface (“UI”) of a software application.

Hover help is sometimes referred to as an “info pop”, and refers to a technique whereby a small window pops up, responsive to an end user pausing a cursor (such as a mouse cursor or other pointing device cursor) temporarily over an icon or other element which is rendered on a user interface and for which hover help has previously been created. This pop-up window displays the previously-created help information pertaining to the icon or element.

### BRIEF SUMMARY OF THE INVENTION

The present invention is directed to appending hover help for a user interface. In one embodiment, this comprises: accepting, from a first executable program, a hover help append for each of at least one element of a user interface of a second executable program; storing each accepted hover help append; and responding to a request for rendering hover help for a selected element of the user interface by rendering any hover help provided by the second executable program for the selected element if no hover help append has been stored for the selected element, and otherwise by concurrently rendering any hover help provided by the second executable program for the selected element and the stored hover help append for the selected element. The request may comprise an event requesting the rendering of the hover help, and this event may identify the selected element for which the rendering of the hover help is requested. Alternatively, the request may be triggered by a cursor moving into a specified range of a location on the user interface, by input from a user, and so forth.

The concurrent rendering may comprise rendering the stored hover help append for the selected element over top of the hover help provided by the second executable program for the selected element. The storing may comprise storing the hover help append on a server accessible to an invocation of an executable program that performs the responding, or perhaps storing the hover help append on local storage of a workstation of a user of the first and second executable programs. The storing may comprise storing the hover help append in a data structure such as a markup language document that is associated with the user interface and that is updatable by the first executable program, in which case the concurrent rendering uses the stored hover help append for the selected element upon retrieval thereof from the markup language document. As an alternative, the storing may comprise storing a reference to a file location of the hover help append and storing the hover help append at the referenced file location, in which case the concurrent rendering uses the stored hover help append for the selected element from the referenced file location, upon retrieval of the reference to the file location.

Embodiments of the present invention may be provided as method, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 provides an example of a complex user interface for an application, according to the prior art;

FIG. 2 illustrates user-provided hover help that will be rendered as extended hover help for an element of a user interface, in addition to the application-provided hover help, according to an embodiment of the present invention;

FIG. 3 depicts an approach for specifying where a user-provided hover help append should be positioned on a panel when rendered;

FIGS. 4-6 illustrate how one embodiment of the present invention accepts user-provided hover help and enables a user to retrieve that hover help;

FIGS. 7-8 depict sample data structures that may be used to record a user's hover help appends;

FIG. 9 provides a flowchart depicting logic which may be used when implementing an embodiment of the present invention;

FIG. 10 depicts a data processing system suitable for storing and/or executing program code; and

FIG. 11 depicts a representative networking environment in which one or more embodiments of the present invention may be used.

### DETAILED DESCRIPTION OF THE INVENTION

Embodiments of the present invention are directed toward enabling end users to append their own hover help to the hover help that is provided for an application's user interface, without having access to the code of the application (which is also referred to herein as the “underlying application”). Typically, the hover help to which the user's hover help is to be appended is originally provided by the software developer for the application. Accordingly, the original hover help is referred to herein (by way of illustration but not of limitation) as “application-provided hover help”. Using techniques disclosed herein, an end user can extend the application-provided hover help information to make it more helpful or tailored to his own needs, even though the application does not provide a mechanism for enabling the user to edit or replace the application-provided hover help.

A user interface rendered by an application program may contain a substantial amount of information, and/or information that is complex or confusing, especially for novice users. Some end users may find that the hover help provided with the application, or perhaps some portion of the hover help, is not particularly helpful to them or does not align with their personal or enterprise-specific interpretation of the rendered data. Or, there may be scenarios where the user prefers using his own separately-stored reference information instead of the application-provided hover help. For example, an end user might create his own separate help documents, procedures, or “cheat sheets” containing reminders or explanations of enterprise-specific conventions, procedures, and practices pertaining to data rendered in an application interface. Such information might explain, for example, how to use particular fields in the user interface when performing enterprise-specific tasks or might remind the user of enterprise-specific settings to be used with tasks pertaining to a particular element of the user interface.

A drawback of this existing approach is that the user's separately-stored information is not rendered with the application-provided hover help. It may therefore be cumbersome for the user to locate his preferred, separately-stored information when it is needed, and he may in some cases forego using his preferred separately-stored information as a result, which in turn may lead to a less-productive or less-accurate interaction with the rendered UI.

The present invention is directed to enabling end users to append their own hover help to the application-provided hover help or, more generally, to append their own hover help to hover help that is provided in a UI of a software application. An embodiment of the present invention provides a mechanism that is external to the application providing the user interface, and allows an end user to specify information to be appended to hover help for user interface elements. This user-provided information is rendered in addition to the original application-provided hover help. Or, by specifying that the information provided by the user is to be displayed in the same location as the application-provided hover help, the user's information can be rendered such that the application-provided hover help is at least partially obscured. In either case, the information provided by the user for the hover help append, which is also referred to herein as “user-provided hover help”, is stored for subsequent use in the application interface.

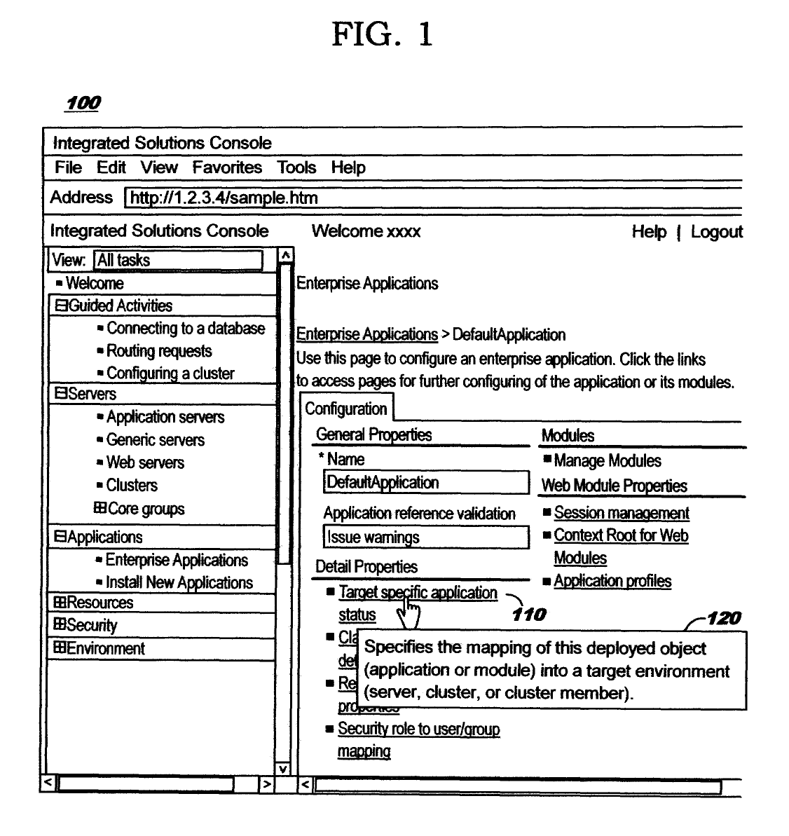

FIG. 1 provides an example of a complex UI 100 for an application. FIG. 1 provides an illustration of hover help according to the prior art, whereby the user has paused the mouse cursor over a hyperlink element having text “Target specific application status”. See reference number 110. This hyperlink text generally describes the function of the display “panel” or screen that the link will open if selected. The hover help window 120 displayed in response to hovering the mouse cursor over this hyperlink 110 contains text stating “Specifies the mapping of this deployed object (application or module) into a target environment (server, cluster, or cluster member).”.

Using an embodiment of the present invention, the user can enter his own help to be appended to the application-provided hover help for a displayed element (including, if desired by the user, an explicit reference to where the user has previously stored separate help information pertaining to this displayed element). Preferably, an append dialog is provided by the external hover help mechanism disclosed herein, such as a dialog window in which the user-provided hover help may be entered by the user. In one aspect, after the user provides this hover help, an embodiment of the present invention prompts the user to indicate a location where the hover help should pop up at run time. This may comprise enabling the user to move the append dialog window by dragging and dropping on the user interface, and the user may select a location related to the particular field of the currently-rendered panel and/or a location related to existing hover help that will be rendered for that field.

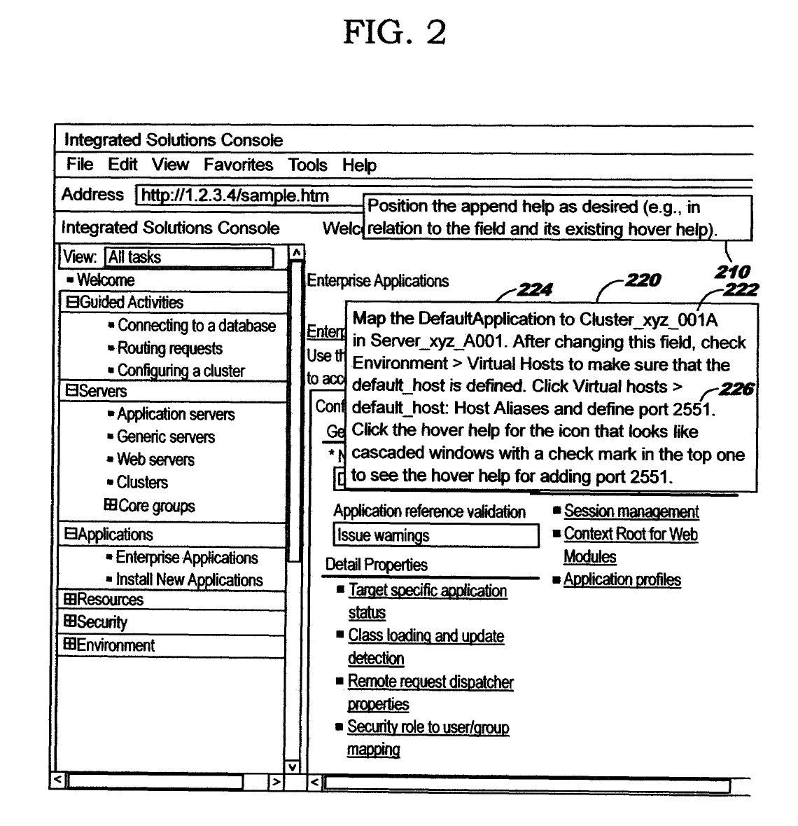

See FIG. 2, which illustrates sample user-provided hover help 220 to be rendered as extended hover help for the hyperlink element 110, in addition to the application-provided hover help 120 shown in FIG. 1. As can be seen by this sample user-provided hover help 220, the hover help 220 is now very specific to the particular enterprise in which this user is working. Hover help 220, in this example, provides four sentences, each of which specifies guidance or reminders regarding particular steps that should be taken by the user as he interacts with the application interface. Hover help 220 also provides, in this example, a number of parameter values that may be specific to this enterprise and that should be used by the user during his interaction with the application interface. See, for example, reference numbers 222, 224, and 226.

As can be seen by comparing the hover help 120 of FIG. 1 to the user-provided hover help 220 of FIG. 2, the extension 220 will enable the hover help, as extended, to generally be more useful to the end user because it describes how to interact with the underlying user interface element in terms that are tailored to this user and his enterprise.

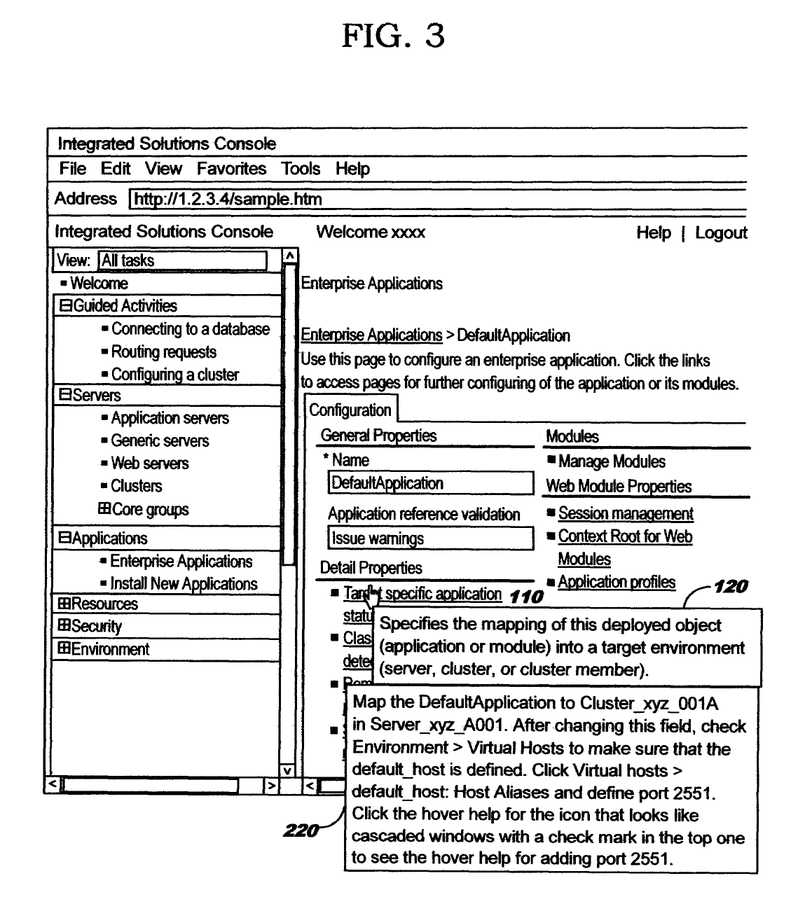

In FIG. 2, the user-provided hover help has not yet been positioned on the panel at a location selected by the user. The instructions shown at 210 prompt the user, in this aspect, to position the user-provided hover help as desired. Accordingly, the user may drag and drop window 220 on the panel. FIG. 3 shows one approach that may be selected by the user, whereby the user-provided hover help 220—which pertains, in this example, to the hyperlink element 110—is positioned beneath the application-provided hover help 120 for element 110.

The user may activate entry of user-provided hover help (i.e., user input of hover help to be appended to, or perhaps displayed over, the already-existing hover help) in various ways without deviating from the scope of the present invention. In one approach, the user activates an executable program that accepts and stores hover help input (which may be referred to as the “hover help entry program”, for ease of reference), as disclosed herein, by clicking on a corresponding icon rendered on a desktop view of the user's workstation. In another approach, the user selects such an executable from a list of available applications presented in the Start menu (or similar menu of applications) provided by the workstation operating system. In yet another approach, the user activates an executable program by pressing a key or key sequence configured to invoke this program (and such key or key sequence may be configurable by the end user). In still another approach, the user types the name of such an executable program on a command line to thereby invoke the program.

At run time, the hover help provided by the user is retrieved and made available for rendering. Preferably, this is facilitated by activating an executable program that runs in a background mode, separate from the underlying application. This executable program (which may be referred to as the “run-time hover help retrieving program”, for ease of reference) may be the same executable program used to enter the user-provided hover help (in which case additional user-provided hover help may be entered at run time of the underlying application for which hover help is provided, if desired), or it may be a different executable program, without deviating from the scope of the present invention. In one approach, the run-time hover help retrieving program is explicitly invoked by the user (e.g., by clicking on an icon; selecting a choice from a menu; pressing a key or key sequence, which may be configurable; or typing the program name into a command line). In another approach, the run-time hover help retrieving program is automatically invoked (e.g., when the user's workstation is booted, responsive to invoking the underlying application program, etc.).

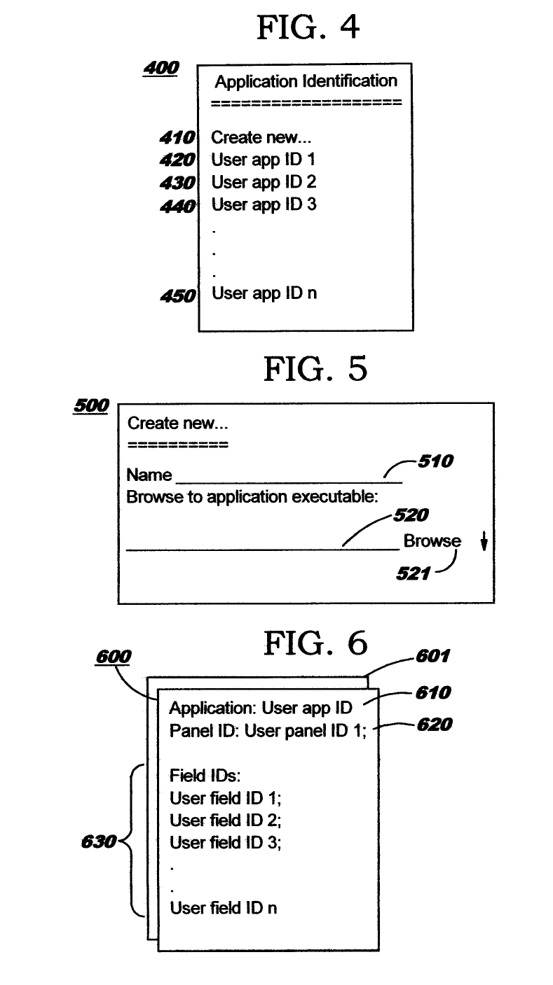

The manner in which one embodiment accepts user-provided hover help using the hover help entry program will now be described in more detail with reference to an example illustrated in FIGS. 4-6.

Referring first to FIG. 4, the hover help entry program may present a panel 400 that allows the user to create a new hover help append and/or to view previously-created hover help appends. As shown therein, the “Create new . . . ” choice 410 may be selected for creating the new hover help append, or any of the existing hover help appends may be viewed by selecting their corresponding entries 420, 430, 440, 450. The “User app ID x” text, where “x” takes on the values 1 through n, as shown in FIG. 4 may be a representation of actual program names. As one alternative, the user may be allowed to specify names that are meaningful to the user but which do not match the actual name of the application (e.g., where the terms “actual name” or “actual program name” are used herein to refer to the name of the executable file for the application). In this latter case, a mapping that associates the user-entered program name to the actual program name may be created or consulted. See FIG. 5, where an entry panel 500 is illustrated that may be used for creating entries for such a mapping. As shown therein, the user enters a user-meaningful program name using entry field 510, and identifies the actual program name to be associated therewith using entry field 520. A browse key or button 521 may be provided, if desired by an implementation of the present invention, to allow the user to select from actual program names that are retrieved and presented in entry field 520 using a drop-down list or other selection technique.

Responsive to identifying a new application using FIG. 5, the hover help entry program may activate the identified application, causing it to render a panel. The user may then provide a hover help append for that panel, for example as has been described above with reference to FIG. 2, or may navigate to a different panel and provide a hover help append for that different panel. Responsive to selecting one of the entries 420, 430, 440, 450 for which hover help appends already exist, an entry panel such as panel 600 of FIG. 6 may be displayed. In one embodiment, the user-provided hover help for each panel of the underlying application that corresponds to the selected entry 420, 430, 440, 450 is retrieved. Panel 600 represents, in this example, the user-provided hover help appends for a single panel of the underlying application, and another panel 601 may be presented to view the user-provided hover help appends for a different panel of that same underlying application. In another approach, not shown in FIG. 6, hover help appends for more than one panel of the underlying application might be presented on a single panel of the hover help entry program. (A panel such as panel 600 may also be used at run time, as discussed in more detail below, to enable the user to explicitly request rendering of a particular hover help append).

In the sample panel 600, the underlying application is identified at 610 and a particular panel of that application is identified at 620. An identifier of each field of this panel 620 may be presented, as shown generally at 630. As one alternative, the entries at 630 may be provided only for those fields for which the user has previously created and stored a hover help append. The user may click one of the entries at 630 to display the previously-stored hover help append in edit mode, and may then revise that hover help append if desired. Or, the user may hover the mouse cursor over an entry from 630 to display the associated hover help append in a hover window. When editing a hover help append, an edit window may provide functions such as delete, edit, save and close, close without saving, and so forth.

In preferred embodiments, the user-provided hover help appends created with the hover help entry program are stored separately from any application-provided hover help. In one approach, user-provided hover help appends are stored as one or more Extensible Markup Language (“XML”) documents that are external to the underlying application. Accordingly, the allowable hover help syntax may adhere to a schema for XML documents. As one alternative, a document or documents encoded in another markup language may be used for storing the user's hover help appends. The user-provided hover help may be stored in product-related data files, according to one embodiment of the present invention. For example, a configuration file associated with a software product may identify a file path or other storage structure to be used for data files associated with applications within that software product. In another embodiment, the user-provided hover help is stored within a user data section of the application directory structure. In yet another embodiment, the user-provided hover help is stored at a location designated by the end user in a preferences file, configuration file, policy file, or other similar mechanism (which may identify, for example a path name or directory structure in which append files created by this user are to be stored).

More generally, the user-provided hover help appends may be stored at a location for which the user has read/write access. In one approach, the user-provided appends are stored in local storage on the user's workstation. In another approach, such appends are stored on a server for which this user has read/write access and that is accessible to an invocation of the hover help entry program and the hover help retrieving program. An administrator may create user-provided appends that are then retrievable for multiple end users of an enterprise, if desired. In this latter approach, the administrator-provided appends to hover help may be stored as user-provided hover help appends on a server from which a plurality of end users then retrieves those files.

The user may enter hover help appends as unformatted text. Optionally, a formatting command or commands may be supported. In one embodiment, a user is allowed to enter a “<p>” (i.e., paragraph) command in the hover help append to indicate that a paragraph break should be provided when the text of the user-provided hover help is rendered. A “<b>” command may also be supported, if desired, thereby allowing the user to indicate that some portion of the user-provided hover help should be rendered in bold face. In addition or instead, an embodiment may support user entry of graphics, such as allowing a user to provide a file path or Uniform Resource Locator (“URL”) that identifies a location of an image file to be rendered within the user-provided hover help for a particular field.

In one approach, the syntax that is allowable for appends to hover help depends on the capabilities of the rendering device, and any valid formatting or highlighting markup syntax or tags may be specified by the user when creating a hover help append. In this approach, any user-provided markup that is not supported by the rendering device is preferably ignored during rendering. Notably, the allowable syntax for hover help appends is independent of the hover help capabilities provided in the underlying application.

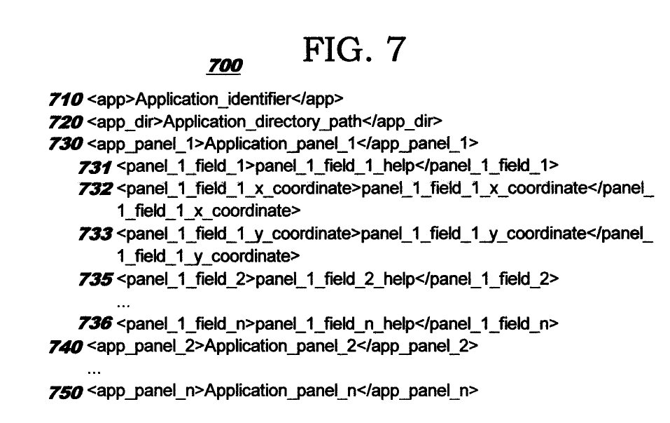

FIG. 7 depicts a sample data structure comprising an XML document 700 which may be used to record a user's hover help appends according to one aspect of the present invention. As shown therein, the sample syntax in XML document 700 specifies hover help append information for each of the panels or screens that may be rendered by a particular application at run time. An <app>tag 710 is used, in this example, to identify the application to which this document 700 pertains, and an <app_dir>tag 720 specifies a file path indicating the directory structure where hover help appends for this underlying application are stored. An <app_panel_x>tag identifies, in this example, each of the panels that may be rendered by this particular underlying application, where “x” takes on values from 1 through the number of application panels. See reference numbers 730, 740, 750. In this sample document 700, a <panel_x_field_y>tag provides the name of a file containing the user-provided hover help append for a particular field “y” of a panel “x” in this application. See, for example, reference numbers 731, 735, 736, which provide names of files containing user-provided hover help. In this example, the user-provided hover help identified at 731 is to be used for “field_{—}1” of “panel_{—}1” at run time as an extension of, or equivalently as an append to, the application-provided hover help for this field (if any).

In one approach, the user specifies (x, y) coordinates for each hover help append. At run-time, the hover help retrieving application runs in a background mode and detects when the user moves the cursor within a particular range of the (x, y) coordinates specified for any of the fields on a particular panel. Suppose, for example, that the particular range is 5 for both the x- and y-coordinates. If the cursor is within 5 units of the x-coordinate identified at 732 and also within 5 units of the y-coordinate identified at 733, then the hover help append identified at 731 is to be rendered (e.g., by popping up a window containing the user's append). The hover help append may be rendered at those same (x, y) coordinates. Or, an offset may be used such that the hover help append is displaced from the area of the panel that triggered the rendering of the hover help append. As yet another option, the user may specify another set of (x, y) coordinates (e.g., as another child element of element 730) to be used as the location for displaying the hover help append. As still another option, the (x, y) coordinates illustrated at 732, 733 may be interpreted as the location for displaying the hover help append identified at 731, and the rendering thereof may be triggered when the user moves the cursor within a particular range of the field that corresponds to this “<panel_{—}1_field_{—}1>” entry in file 700. Or, the rendering thereof may be triggered by displaying a list of all existing hover help appends for a particular rendered panel, and allowing the user to explicitly request rendering of a hover help append selected using this list. In this case, the list may be structured as illustrated by panel 600 of FIG. 6.

In the general case, (x, y) coordinates used by an embodiment of the present invention are preferably specified relative to the upper left corner of the application panel. In one approach, when a range is used in combination with (x, y) coordinates for determining when the display of a hover help append is triggered, this range is configurable. In another approach, this range may be statically specified (e.g., by the hover help retrieving program).

In another approach, the hover help retrieving program does not receive information about the cursor's current location. In this approach, the user may render hover help for fields of the panel through user interaction. For example, the user may press a key or key sequence, or select a choice from a menu, to thereby request display of a list or other rendering of the hover help appends which are available for this panel, as mentioned above. (It may also be necessary, in some implementations, for the user to first identify the current application and/or panel to the hover help retrieving program. This may be facilitated, for example, by displaying panels such as those illustrated in FIGS. 4-6 and allowing the user to make selections therefrom). The list or other rendering of available hover help appends may be shown, for example, using the field names for which hover help is available or the file names of such hover help. When the available hover help appends are shown to the user, the user may then select one of the entries from the list or other rendering, and responsive to this selection, the content of that hover help is then rendered. When (x, y) coordinates are specified for displaying a hover help append in this approach, the hover help append is preferably rendered at those (x, y) coordinates.

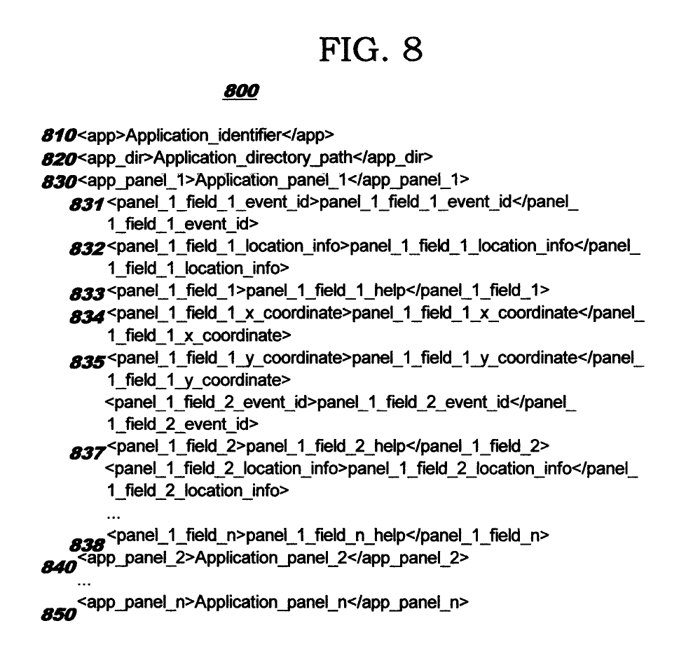

FIG. 8 depicts a sample data structure comprising an XML document 800 which may be used to record a user's hover help appends according to another aspect of the present invention. Similar to the example document 700 of FIG. 7, the sample syntax in XML document 800 specifies hover help append information for each of the panels or screens that may be rendered by a particular application at run time; an <app>tag 810 is used, in this example, to identify the application to which this document 800 pertains; and an <app_dir>tag 820 specifies a file path indicating the directory structure where hover help appends for this application are stored. An <app_panel_x>tag identifies, in this example, each of the panels that may be rendered by this particular underlying application, where “x” takes on values from 1 through the number of application panels. See reference numbers 830, 840, 850. In this sample document 800, a <panel_x_field_y>tag provides the name of a file containing the user-provided hover help append for a particular field “y” of a panel “x” in this application. See, for example, reference numbers 833, 837, 838, which provide names of files containing user-provided hover help. In this example, the user-provided hover help identified at 833 is to be used for “field_{—}1” of “panel_{—}1” at run time as an extension of, or equivalently as an append to, the application-provided hover help for this field (if any).

The approach shown in FIG. 8 differs from that of FIG. 7 in that document 800 represents, in this example, hover help appends that are to be rendered upon occurrence of some detected event. This approach may be used with underlying applications that publish event data related to panel names, field names, and/or hover help names. For example, an underlying application may use an event-driven mechanism for requesting the rendering of hover help, whereby an event is published that signifies “display the hover help associated with field y on panel x”. An event listener, according to this approach, receives the event and retrieves the application-provided hover help associated therewith. An embodiment of the present invention may also listen for such events as a trigger for rendering a user-provided hover help append. Existing techniques are preferably used for identifying the currently-rendered panel, and the panel identification may be included in published events for enabling the hover help retrieving application to locate the hover help appends corresponding to that panel. Similarly, existing techniques may be used to determine the cursor's position relative to the fields of the panel, and this information may be included in the published events for enabling the hover help retrieving application to locate the hover help appends corresponding to each of the fields of the panel. Or, an event identifier may be provided in the event, where this event identifier is determined using existing techniques (such as using the panel identifier and field identifier to consult a mapping). An event may comprise the user positioning to a particular tab stop (responsive, for example, to the user using tab keys to move from one field to another), and this tab stop information may be used to determine which hover help append (if any) is pertinent at a particular point in time.

Document 800 also illustrates identification of an event that triggers the rendering of the hover help for a particular field. See reference number 831, where an event identifier may be specified. Location information may also be specified, as indicated at reference number 832, as a field counter, number of tab stops, or other location information that is derived from the application. Document 800 may also specify (x, y) coordinates, as illustrated at 834, 835, to indicate a position on the application panel where the hover help append identified at 833 should be rendered. If the location information at 832 is x and y location coordinates of the field, the data is parsed programmatically into x and y coordinates and a default offset is added to each coordinate for use in positioning the x and y coordinates for the help specified at 834 and 835. If the field location information is not provided in the event data or consumable from the application, the user can position the help to generate the x and y coordinates. (Note that the hover help append value specified as the value of syntax element 833 of FIG. 8, and also as the value of syntax element 731 of FIG. 7, may comprise the actual hover help information, as an alternative to specifying a file name as the value of those syntax elements, without deviating from the scope of the present invention).

When a hover help append is rendered at run time, it is preferably rendered using a separate window that is opened on top of the application window of the underlying application. This separate window may open over top of the application-provided hover help to effectively obscure that application-provided hover help, or the window may open such that the application-provided hover help is concurrently visible, as mentioned earlier. In one approach, an embodiment of the present invention does not automatically close the window in which the hover help append is rendered; instead, the user manually closes the window (preferably using an existing approach such as clicking on a graphic such as an “X” icon or a “Close” button).

Note that an embodiment of the present invention may provide, and render, hover help for a field for which application-provided hover help does not exist.

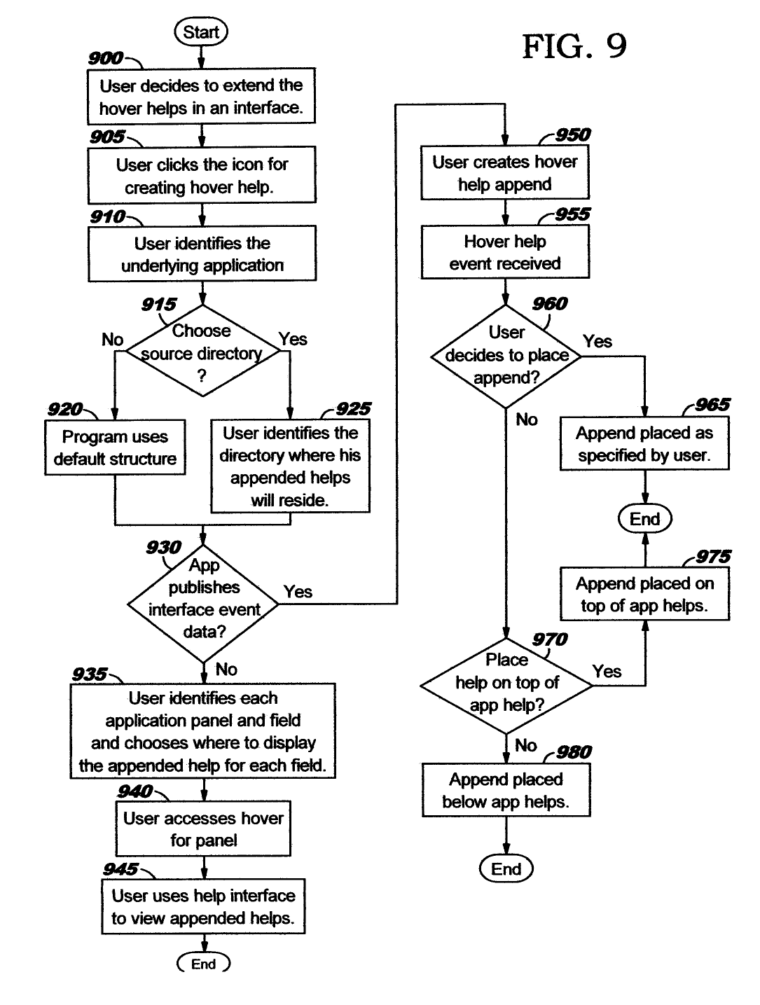

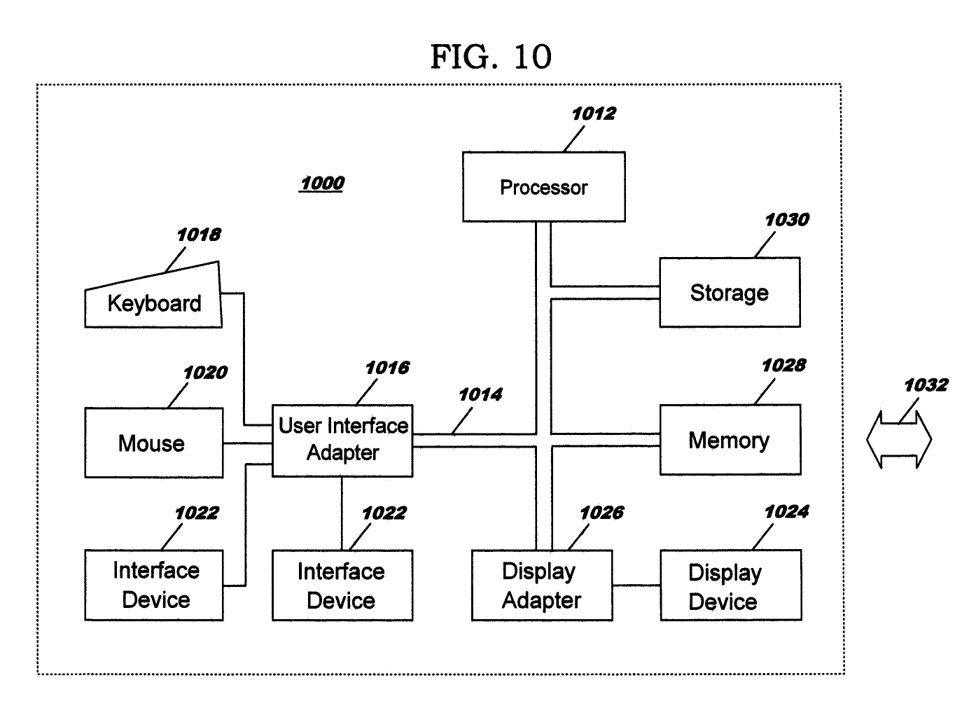

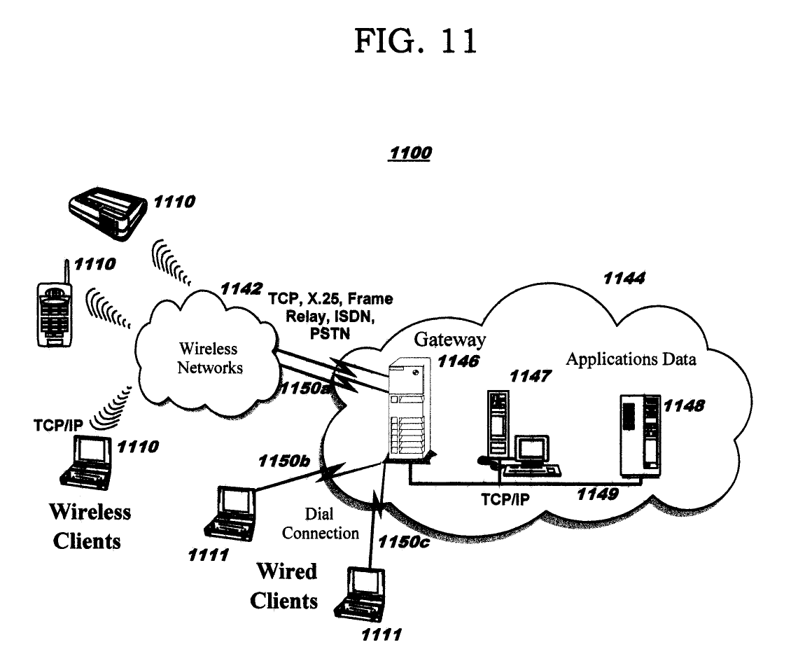

Turning now to FIG. 9, a flowchart is provided depicting logic that may be used when implementing an embodiment of the present invention. As shown therein, a user decides at some point to extend the hover help (or multiple hover helps) provided by an application (Block 900). Accordingly, the user presses a hot key, function key, key sequence, or right-clicks an icon or menu item that activates the hover help entry program (Block 905). Block 910 indicates that the user identifies the underlying application for which hover help is to be extended. This may comprise using a panel such as panel 400 of FIG. 4 (and optionally panel 500 of FIG. 5), as described earlier.

An embodiment of the present invention may ask the user to explicitly identify where files such as document 700 of FIG. 7 and document 800 of FIG. 8 are to be stored. Accordingly, Block 915 asks whether the user will choose the source directory (i.e., the file storage location for hover help appends). If this test has a negative result, then at Block 920, a default directory structure is used (where this default directory structure may be determined by consulting a preferences file, configuration file, using the installation directory of the selected underlying application, etc.). Otherwise, at Block 925, the user identifies the directory where the hover help appends will reside.

In either case, processing reaches Block 930, which tests whether the underlying application publishes event data pertaining to its user interface. If not, then processing continues at Block 935; otherwise, processing continues at Block 950. Note that the decision reflected in Block 930 is not necessarily made programmatically. As one alternative, a software developer of an embodiment of the present invention determines whether the underlying application(s) with which the implementation of the present invention will be used will provide event data. If not, then this implementation may implement the functions represented by Blocks 935-945 and may omit the functions represented by Blocks 950-980. Conversely, if it is known that the underlying application(s) will provide event data, then an implementation of the present invention may implement the functions represented by Blocks 950-980 and may omit the functions represented by Blocks 935-945.

Referring now to Block 935, as indicated therein, the user provides hover help appends for each panel and field of an application for which such appends are desired, and chooses where to display such appends. The location for displaying each append may be specified relative to the upper left corner of the panel, as noted earlier.

When hover help appends are provided using a hover help entry program that is separate from a run-time hover help retrieving program, the processing of FIG. 9 may exit following completion of Block 935. The run-time hover help retrieving program may then be invoked by selecting a corresponding icon or using other invocation techniques, as discussed above, and run-time processing may then continue at Block 940. Alternatively, when a single program is used for both hover help entry and run-time hover help retrieving, processing may continue at Block 940, following execution at Block 935, without a separate program invocation. In either approach, Block 940 indicates that the user accesses the previously-stored hover help appends for the currently-displayed panel. This may comprise, for example, asking the user to explicitly identify the currently-displayed panel or otherwise determining the current panel, and locating the hover help appends associated therewith, as has been discussed earlier. In Block 945, the user then views the hover help append for a field or fields of this panel, which may comprise asking the user to explicitly select a hover help append for rendering from a list of available hover help appends, as has also been discussed earlier. Processing in FIG. 9 may then exit. Alternatively, processing of FIG. 9 may iterate, for example responsive to the user selecting a different panel of this application or a panel of a different application and then interacting with the hover help appends for that panel.

Referring now to Block 950, a hover help append is created by the user to extend an application-provided hover help that has a corresponding hover help event. When hover help appends are provided using a hover help entry program that is separate from a run-time hover help retrieving program, the processing of FIG. 9 may exit following Block 950. The run-time hover help retrieving program may then be invoked by selecting a corresponding icon or using other invocation techniques, as discussed above, and run-time processing may then continue at Block 955. Alternatively, when a single program is used for both hover help entry and run-time hover help retrieving, processing may continue at Block 955 without a separate program invocation.

In either approach, Block 955 indicates that a hover help event is received. After receiving this event, Block 960 tests, in one approach, whether the user will explicitly decide where to place a previously-created hover help append that is associated with that event (e.g., through an entry such as that illustrated at 831 of FIG. 8). If this test has a positive result, then at Block 965, the append is to be placed as specified by the user. For example, (x, y) coordinates entered by the user may be retrieved and used for positioning the hover help append, as has been discussed above with regard to reference numbers 834 and 835 of FIG. 8.

When the test in Block 960 has a negative result, then the hover help append is to be placed on the user interface at a programmatically-determined location. Accordingly, in Block 970, a test is made to determine whether the hover help append is to be placed on top of the application-provided hover help. (This test may consult previously-created user preferences, a configuration file, and so forth). If this test has a positive result, then at Block 975, the user-provided hover help append is positioned on top of the application-provided hover help for the element to which the received event pertains; otherwise, at Block 980, the user-provided hover help append is positioned such that it is displayed concurrently with the application-provided hover help. In this latter case, the hover help append may be positioned below the application-provided hover help.

Following any of Blocks 965, 975, or 980, processing in FIG. 9 may exit. Alternatively, processing of FIG. 9 may iterate, for example responsive to receiving another hover help event pertaining to the currently-rendered panel or perhaps pertaining to a different panel.

As one alternative to using a document such as document 700 of FIG. 7 or document 800 of FIG. 8 to record hover help append information, an embodiment of the present invention might use a table or other data structure for recording such information. As yet another alternative to using an XML document for identifying hover help files, a properties file might specify hover help (e.g., as plain text) and its associated information as described herein. As another alternative, a document encoded in the Hypertext Markup Language (“HTML”) or other markup language might specify hover help and its associated information.

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

Referring now to FIG. 6, a data processing system 600 suitable for storing and/or executing program code includes at least one processor 612 coupled directly or indirectly to memory elements through a system bus 614. The memory elements can include local memory 628 employed during actual execution of the program code, bulk storage 630, and cache memories (not shown) which provide temporary storage of at least some program code in order to reduce the number of times code must be retrieved from bulk storage during execution.

Input/output (“I/O”) devices (including but not limited to keyboards 618, displays 624, pointing devices 620, other interface devices 622, etc.) can be coupled to the system either directly or through intervening I/O controllers or adapters (616, 626).

Network adapters may also be coupled to the system to enable the data processing system to become coupled to other data processing systems or remote printers or storage devices through intervening private or public networks (as shown generally at 632). Modems, cable modem attachments, wireless adapters, and Ethernet cards are just a few of the currently-available types of network adapters.

FIG. 7 illustrates a data processing network environment 700 in which the present invention may be practiced. The data processing network 700 may include a plurality of individual networks, such as wireless network 742 and network 744. A plurality of wireless devices 710 may communicate over wireless network 742, and a plurality of wired devices, shown in the figure (by way of illustration) as workstations 711, may communicate over network 744. Additionally, as those skilled in the art will appreciate, one or more local area networks (“LANs”) may be included (not shown), where a LAN may comprise a plurality of devices coupled to a host processor.

Still referring to FIG. 7, the networks 742 and 744 may also include mainframe computers servers, such as a gateway computer 746 or application server 747 (which may access a data repository 748). A gateway computer 746 serves as a point of entry into each network, such as network 744. The gateway 746 may be preferably coupled to another network 742 by means of a communications link 750a. The gateway 746 may also be directly coupled to one or more workstations 711 using a communications link 750b, 750c, and/or may be indirectly coupled to such devices. The gateway computer 746 may be implemented utilizing an Enterprise Systems Architecture/390® computer available from IBM. Depending on the application, a midrange computer, such as an Application System/400® (also known as an AS/400®) may be employed. (“Enterprise Systems Architecture/390”, “Application System/400”, and “AS/400” are registered trademarks of IBM in the United States, other countries, or both).

The gateway computer 746 may also be coupled 749 to a storage device (such as data repository 748).

Those skilled in the art will appreciate that the gateway computer 746 may be located a great geographic distance from the network 742, and similarly, the wireless devices 710 and/or workstations 711 may be located some distance from the networks 742 and 744, respectively. For example, the network 742 may be located in California, while the gateway 746 may be located in Texas, and one or more of the workstations 711 may be located in Florida. The wireless devices 710 may connect to the wireless network 742 using a networking protocol such as the Transmission Control Protocol/Internet Protocol (“TCP/IP”) over a number of alternative connection media, such as cellular phone, radio frequency networks, satellite networks, etc. The wireless network 742 preferably connects to the gateway 746 using a network connection 750a such as TCP or User Datagram Protocol (“UDP”) over IP, X.25, Frame Relay, Integrated Services Digital Network (“ISDN”), Public Switched Telephone Network (“PSTN”), etc. The workstations 711 may connect directly to the gateway 746 using dial connections 750b or 750c. Further, the wireless network 742 and network 744 may connect to one or more other networks (not shown), in an analogous manner to that depicted in FIG. 7.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention. Furthermore, while the discussion herein may refer to “an embodiment” or “one embodiment” of the present invention, such references are not necessarily discussing the same embodiment.

1. A computer-implemented method of appending hover help for a user interface, comprising:
accepting, from a first executable program, a hover help append for each of at least one element of a user interface of a second executable program;
storing each accepted hover help append; and
responding to a request for rendering hover help for a selected element of the user interface by rendering any hover help provided by the second executable program for the selected element if no hover help append has been stored for the selected element, and otherwise by concurrently rendering any hover help provided by the second executable program for the selected element and the stored hover help append for the selected element.

2. The method according to claim 1, wherein the request comprises an event requesting the rendering of the hover help.

3. The method according to claim 2, wherein the event identifies the selected element for which the rendering of the hover help is requested.

4. The method according to claim 1, wherein the request is triggered by a cursor moving into a specified range of a location on the user interface.

5. The method according to claim 4, wherein the location comprises a location for the rendering of the hover help on the user interface.

6. The method according to claim 4, wherein the location comprises a location of the selected element on the user interface.

7. The method according to claim 1, wherein the request is triggered by input from a user.

8. The method according to claim 7, wherein the input from the user comprises moving a cursor within a particular range of a rendering of the selected element on the user interface.

9. The method according to claim 7, wherein the input from the user comprises the user selecting a representation of the hover help append from a display of available hover help appends for the user interface.

10. The method according to claim 1, wherein the concurrent rendering comprises rendering the stored hover help append for the selected element over top of the hover help provided by the second executable program for the selected element.

11. The method according to claim 1, wherein the accepting is triggered responsive to activation of a key or key sequence from the first executable program.

12. The method according to claim 1, wherein the storing comprises storing the hover help append on a server accessible to an invocation of an executable program that performs the responding.

13. The method according to claim 1, wherein the storing comprises storing the hover help append on local storage of a workstation of a user of the first and second executable programs.

14. The method according to claim 1, wherein the storing comprises storing the hover help append in a data structure that is associated with the user interface and updatable by the first executable program.

15. The method according to claim 14, wherein the data structure comprises a markup language document.

16. The method according to claim 1, wherein:
the storing comprises storing the hover help append in a markup language document that is associated with the user interface and that is updatable by the first executable program; and
the concurrently rendering uses the stored hover help append for the selected element upon retrieval thereof from the markup language document.

17. The method according to claim 1, wherein:
the storing comprises storing, in a markup language document that is associated with the user interface and that is updatable by the first executable program, a reference to a file location of the hover help append and storing the hover help append at the referenced file location; and
the concurrently rendering uses the stored hover help append for the selected element from the referenced file location, upon retrieval of the reference to the file location from the markup language document.

18. A hover help modifying system for appending hover help for a user interface, comprising:
a computer comprising a processor; and
instructions which execute using the processor to implement functions comprising:
accepting, from a first executable program, a hover help append for each of at least one element of a user interface of a second executable program;
storing each accepted hover help append; and
responding to a request for rendering hover help for a selected element of the user interface by rendering any hover help provided by the second executable program for the selected element if no hover help append has been stored for the selected element, and otherwise by concurrently rendering any hover help provided by the second executable program for the selected element and the stored hover help append for the selected element.

19. A computer program product for appending hover help for a user interface, the computer program product embodied on one or more computer-usable media and comprising computer-usable program code for:
accepting, from a first executable program, a hover help append for each of at least one element of a user interface of a second executable program;
storing each accepted hover help append; and
responding to a request for rendering hover help for a selected element of the user interface by rendering any hover help provided by the second executable program for the selected element if no hover help append has been stored for the selected element, and otherwise by concurrently rendering any hover help provided by the second executable program for the selected element and the stored hover help append for the selected element.

20. The computer program product according to claim 19, wherein:
the storing comprises storing, in a markup language document that is associated with the user interface and that is updatable by the first executable program, a reference to a file location of the hover help append and storing the hover help append at the referenced file location; and
the concurrently rendering uses the stored hover help append for the selected element from the referenced file location, upon retrieval of the reference to the file location from the markup language document.
